(19) United States
(12) Patent Application Publication
(10) Pub. No.: US 2023/0038303 A1
(43) Pub. Date: Feb. 9, 2023

(54) THRIPS CONTROL

(71) Applicant: Protix B.V., Dongen (NL)

(72) Inventors: Thijs Kapteijns, Dongen (NL); Aman Paul, Dongen (NL); Seyed Ali Hosseini, Dongen (NL)

(73) Assignee: Protix B.V., Dongen (NL)

(21) Appl. No.: 17/786,579

(22) PCT Filed: Dec. 18, 2020
(86) PCT No.: PCT/NL2020/050808

§ 371 Date: Jun. 17, 2022

(30) Foreign Application Priority Data
Dec. 24, 2019 (NL) 2024574

(51) Int. Cl. A01N 63/14; A01P 7/04

(52) U.S. Cl. CPC A01N 63/14; A01P 7/04

(57) ABSTRACT

The invention concerns crop protection, in particular the prevention and treatment of infestations of agricultural crops by pest insects, such as insects belonging to the Thysanoptera order (Thrips). The invention is predicated on the finding that thrips sensitive crops benefit significantly from treatment with a biological crop protection agent derived from (industrial) insect farming by-products. Treatments of the invention not only result in an overall reduction in the number of thrips on the crop (as compared to untreated crop), but also in an overall increase in crop yield and quality. The invention provides the crop protection agent, methods of treating agricultural and/or horticultural crop using the crop protection agent and uses of said crop protection agent for treating agricultural and/or horticultural crop.

### FIELD OF THE INVENTION

The present invention concerns the field of crop protection, in particular the prevention and treatment of infestations of agricultural crops by pest insects, such as insects belonging to the Thysanoptera order (Thrips). The present invention provides compositions that can be used for these purposes as well as the corresponding methods and uses.

### BACKGROUND OF THE INVENTION

One of the most notorious pests in both agri- and horticulture is Thrips (Thysanoptera), such as Western Flower Thrips (WFT) (Frankliniella occidentalis). These thrips pose a major problem due to their broad range of hosts, their small size making them hard to detect and their fast and high reproduction rate. While thrips species may typically hibernate in cold winters, they tend to cause problems throughout the entire year in (e.g.) greenhouses.

Thrips cause direct damage to crop by their feeding behavior. Thrips are cell feeders, meaning that they pierce and suck up the whole content of cells of e.g. leaf and flower cells. When the content of mesophyll and epidermal cells is sucked up, the surrounding cells are also damaged by the insertion of the stylet. Feeding on expanding tissue leads to local necrosis appearing as scars. The scarring is called “silvery appearance/damage” and is caused by air filling of the empty cells. Scarring leads to a reduced photosynthesis capacity of the host plant causing reduced yields as well as a lower marketing quality in ornamentals due to cosmetic damage. Feeding on developing tissues leads to stunted and deformed plant growth causing malformation of flowers and fruits. In addition, leaves and flowers are also damaged when females deposit their eggs within the tissue using their curved ovipositors. Indirect damage can occur through virus transmission. Thrips are vectors of several destructive plant viruses. Over 20 plant-infecting viruses are known to be transmitted by thrips, including Tospoviruses such as the tomato spotted wilt virus and the impatiens necrotic spot virus. The western flower thrips, which has a worldwide distribution, is the primary vector of plant diseases caused by tospoviruses. Some of these viruses can severely damage or kill certain vegetable crops and herbaceous ornamentals.

Thrips cause substantial economic loss. For example in 1998 annual damage caused by F. occidentalis in greenhouse vegetable and ornamental crops in the Netherlands alone was calculated to be around 55 million euro (Roosjen et al., Verbetering schade-inschattingsmodel quarantaineorganismen glastuinbouw., PD & LEI-DLO, Wageningen 1998). In relation to an ‘awareness campaign’ in 2013 (forumphyto, 2013; Minor use, major value), it was estimated that spring thrips threaten 15-20% of persimmon cultivation areas in Spain with an economic impact of 18-24 million euro.

Strategies for managing thrips include chemical, biological, behavioral and cultural control. Currently, the main method to control thrips is the use of synthetic insecticides. Contact insecticides must be applied to thoroughly cover buds, shoot tips, and other susceptible plant parts where thrips are present. Contact insecticides do not leave persistent residues. To be effective, contact insecticides have to be applied periodically, with a frequency as high as every 3-4 days, for as long as pest thrips and susceptible plant parts are both present. Thus, the use of contact insecticides has some serious practical disadvantages. Systemic insecticides are absorbed by a plant part (e.g., roots) and translocated to other plant parts. Trunk spray or injection of an effective, systemic insecticide can provide relatively rapid control. With soil drench or injection, there is a longer time delay between application and insecticide action. Known systemic insecticides have low, moderate, or severe adverse impact on natural enemies and pollinators.

The rate at which thrips develops resistance against insecticides is another serious concern. Since there are not that many effective insecticides registered for control of thrips, rotation between insecticides is difficult. In addition, host crops are in continuous production, and resistant thrips may migrate within and among crops, thus increasing exposure to insecticide sprays. For F. occidentalis resistance against various insecticides (e.g., pyrethroids, organophosphates and carbamates) has been encountered already.

For biological thrips control, predatory mites, bugs and entomopathogens are used while for cultural control mechanical trapping and trap plants are used. The manipulation of adult/mature insect behavior is altered using pheromones (for intraspecific communication between arthropods) and allelochemicals (for mediation of plant-insect interactions). In addition, plant volatiles are combined to use pull-push strategies and to increase the efficiency of mechanical practices.

The use of resistant cultivars is another promising strategy in Thrips management. Plants have evolved a variety of defense mechanisms, constitutive and inducible, to reduce insect attacks. Induced defenses are regulated by a network of cross-communicating signaling pathways. The plant hormones salicylic acid and jasmonic acid, as well as ethylene, trigger naturally occurring chemical responses protecting plants from insects and pathogens. Biotechnological advancement has made it easier to detect resistant cultivars against thrips.

The best way to control thrips would be to eventually use all tactics in integrated pest management (IPM) programs. To date, however, the thrips IPM is still largely based on the application of chemical pesticides. There is, therefore, still an urgent need for new and more environmentally friendly control tools and strategies. It is an objective of the present invention to provide such new thrips control strategies.

### SUMMARY OF THE INVENTION

The present invention is predicated on the finding that thrips sensitive crops benefit significantly from treatment with a biological crop protection agent derived from (industrial) insect farming by-products. Experiments have shown that treatments in accordance with the invention result in an overall reduction in the number of thrips on the crop (as compared to untreated crop) as well as an overall increase in crop yield and quality, as is described in more detail and illustrated herein.

The crop protection agent used in accordance with the invention is based on or produced from a by-product from insect farming, wherein in particular the insects are Hermetia illucens larvae. Insect farming refers to the large-scale (industrial) breeding and processing of insects, which are quickly gaining popularity as an alternative source of (nutritional) proteins and fat. In insect framing, suitable insect species, such as black soldier fly larvae, are reared on an organic substrate. In the process, insects and insect larvae, preferably Hermetia illucens larvae. feed on the substrate and deposit their excrements/feces (also referred to as ‘frass’) in the substrate. Insect remains, such as dead bodies and exoskeleton material shed from the larvae during their normal growth and development, end up in the substrate as well. In accordance with the invention, spent breeding substrate, comprising insect remains, excrements, and other materials, has proven to be a very effective agent in reducing and/or controlling insect pest population, as described and illustrated herein. Without wishing to be bound by any theory, the present inventors believe that after treatment of the soil with the crop protection agent produced from spent substrate, e.g. by processing it into a meal or powder, the crop growing in the soil takes up certain components from the agent and/or degradation products thereof, as e.g. produced by soil bacteria. The uptake of these components and/or degradation products is presumed to enhance the crop's chemical and/or mechanical defense mechanisms against insects, such as thrips. Treatment in accordance with the invention could induce plant resistance through e.g., the release of plant chemicals/hormones that act as an alarm signal for adjacent plants and activates the natural defensive response of a plant. This is also referred to in the art as ‘elicitor activity’

A further particular advantage of the treatments of the invention is that it is much more environmentally friendly than chemical insecticide-based treatment and would fit the principles of ‘sustainable agriculture’, among other reasons because of the fact that increasing plant resistance does not result in a direct attack on all insects in the area, in the way that chemical pesticides do. At the same time, a product stream what was previously considered a waste-stream is turned into value and put to use.

To the best of the inventor's knowledge the use of compositions derived from insect farming for soil treatment for the purposes of the present invention has never been suggested in the art. It has been proposed in the art that chitin, the main component of the larval exoskeleton, can be used for control of pathogenic nematodes by acting as a prebiotic promoting the growth of the beneficial chitinolytic microbes that parasitize the eggs of the nematodes. Another hypothesis is that the chitin breaks down in the soil to release nematicidal levels of ammonia. Furthermore, chitosan, a linear polysaccharide that is produced by deacetylation of chitin, has been suggested to act as insecticide for aphids and moths, after ‘coating’ seeds and/or leafs (by spraying or dipping treatments). Synthetic as well as natural compounds capable of inhibiting key enzymes involved in chitin synthesis (such as trehazolin and allosamidin, two pseudo-saccharides, nikkomycin) are in use as insecticides. These agents interfere with the normal growth and development of larvae and insects that require chitin for their exoskeleton. Document WO 2015/013826 is directed to the use of black soldier fly frass for reducing or inhibiting Coleopteran insect pest, wherein the frass is applied to the soil or to the crop. Experimental results are described showing that soil treatment with frass is effective in combatting wireworms, especially A. lineatus, A. obscurus and L. canus, as well as chafer (Scarabidae) and cabbage root maggots, all living in the soil.

Treatments as currently proposed, combatting thrips are not suggested by the state of the art. The present invention thus provides, for the first time, a method of controlling thrips pest in an agricultural or horticultural crop, said method comprising applying to the crop or to the soil in which the crop is grown an effective amount of a crop protection agent, said crop protection agent comprising chitin containing insect particles.

Hence, in a first aspect of the invention, the crop protection agent suitable for use in the methods described herein are provided.

In another aspect, the invention provides methods of treating agricultural and/or horticultural crop using the crop protection agent of the invention.

In another aspect, the invention provides the use of said crop protection agent for treating agricultural and/or horticultural crop.

These and other aspects of the present invention will become apparent to those of ordinary skill in the art, based on the following detailed description and examples.

### DETAILED DESCRIPTION OF THE INVENTION

In accordance with a first aspect of the invention, a biological crop protection agent is provided. The crop protection agent can be produced from certain product streams typically obtained in (industrial) insect rearing processes, preferably industrial Hermetia illucens larvae rearing processes, often colloquially referred to as ‘insect farming’. In recent years, interest in insects as alternative source for (nutritional) proteins and fats has rapidly grown. In order to obtain proteins and fats from insects in an economically feasible manner, insect rearing processes have been developed and implemented that can produce and process large numbers/volumes of insects, often in a highly automated fashion. Insects that are (nowadays) typically ‘farmed’ include flies, bugs, mosquitos, butterflies, moths, cicadas, termites, bees, ants, wasps, beetles, grasshoppers, or crickets. Insect farming essentially entails breeding and rearing of insects on a substrate that is often tailored to maximize conversion of the substrate into insect and larval biomass. At a certain point in the process, larvae and insects, preferably Hermetia illucens larvae, are separated from the substrate for down-stream processing (extraction of proteins and fat). Spent substrate from which the larvae and insects have been separated is currently considered a waste-stream. The present inventors have found however that the spent substrate has utility as a crop protection agent.

The spent substrate typically comprises insect remains, preferably remains of Hermetia illucens larvae, in the form of dead insects, dead insect body parts as well as exoskeleton material. In normal growth and development, larvae routinely cast off their exoskeleton in order to facilitate growth and/or to permit metamorphosis. This process is also referred to as ecdysis or shedding. The larval exoskeleton sheds mainly comprise chitin, which is a polysaccharide containing N-acetylglucosamine. It has been established that the larval exoskeleton material deposited in the substrate contribute to its efficacy as crop protection agent. Although the inventors do not wish to be bound by any theory, it is assumed that chitin is an important component for these purposes.

The spent substrate typically further contains excrements from the larvae and insects bred on the substrate. Insects and insect larvae have an alimentary canal wherein digestion of food/substrate takes place. In this process enzymes and saliva are added to the substrate and nutrients and other components are extracted. The digested substrate excreted from the alimentary canal is referred to herein as ‘excrement’. Although the inventors do not wish to be bound by any theory, it is assumed that the excrements in the spent substrate may contribute to its activity as crop protection agent.

In embodiments of the invention the spent insect substrate, comprises other waste products, besides insect remains and excrements, such as insect eggs, insect egg shells, insect pupae, insect prepupae, insect imago, mature insect, insect embryo, mature larvae, insect intestine, chitin exterior skeleton, wings, legs, heads, thorax, abdomen.

In this document, the term ‘insect particles’ is used to collectively refer to all matter originating from the insects, i.e. the insect remains, excrements and other waste products.

In particularly preferred embodiments of the invention the crop protection agent is produced by taking an appropriate product stream from an insect breeding process, such as the spent substrate and subjecting it to one or more further operations, so as to process it into a form that is suitable for use in soil. In a preferred embodiment of the invention, the process comprises the step of subjecting the product stream, such as the spent substrate and/or the extracted larval mass, to an operation such as milling, grinding, pulverizing or the like, so as to convert it into a powder or meal. Optionally, the process further comprises an operation wherein the moisture is adjusted, typically lowered, and/or an operation wherein the product is pasteurized or sterilized, and/or an operation wherein the product is filled in a suitable package. It is preferred that the insects are Hermetia illucens larvae.

Hence, in accordance with particularly preferred embodiments of the invention, a crop protection agent is provided that is obtainable by an insect rearing process as defined herein, comprising the steps of:

providing a substrate;

inoculating the substrate with insects;

allowing the insects to grow and, if possible and suitable, optionally multiply on the substrate;

harvesting insects from the spent substrate and collecting the spent substrate; and

optionally subjecting the spent substrate to one or more further operations, in particular to one or more further operations selected from milling or grinding; drying; mixing with one or more additives; and packaging. The present invention also relates to these processes per se. It is preferred that the insects are Hermetia illucens larvae.

The down-stream processing of the live insects and larvae to extract the protein and fats (e.g. in accordance with process disclosed in WO 2014/123420, the entire content of which is incorporated herein by reference; in particular the process outlined as Example 1) yields a residual fraction rich in chitin, which is also believed to have utility as a crop protection agent. The use of this extracted larval mass, optionally after subjecting it to one or more further processing steps, as a crop protection agent is also within the scope of the invention.

As used herein, the term “insect” has its regular scientific meaning and refers to all stages of an insect, e.g. embryo, imago, egg, pupae, mature insect, neonate larvae, larvae, prepupae. The term insects in the context of the invention may refer to arthropods, mites, flies, and to black soldier fly (Hermetia illucens), in particular the larval stage thereof, house fly (Musca domestica), mealworm (Tenebrio molitor L.), Lacewings (e.g. Chrysoperla carnea), lesser mealworm (Alphitobius diaperinus), Coccinelid beetles (e.g. Cryptolaemus montrouzieri), any species of predatory bugs (e.g. Macrolophus pygmaeus), other insects, such as pollinators (e.g. the onion fly, Delia antiqua) and any species of predatory beetles (e.g. the greenhouse rove beetle, Dalotia coriaria), as well as terrestric fly species. In one preferred embodiment of the invention, the insects are black soldier flies (Hermetia illucens). Black soldier flies have a particularly high feed conversion ratio and favorable cycle-time compared to other insects and can convert and recover nutrients from a vast variety of organic substrate materials. It is preferred that the insects are Hermetia illucens larvae.

In preferred embodiments of the invention, the substrate comprises one or more of a grain or a constituent thereof, a tuber of a root vegetable or parts or a constituent thereof, wood such as saw dust, shredded branches, a fruit, a vegetable, a crop, a plant, or a fragment, constituent or part thereof. In an embodiment of the invention the grain is one or more of wheat, maize, corn, soy, bran, rice, and/or wherein the tuber of a root vegetable is one or more of potato, cane, carrot. In an embodiment of the invention, the substrate comprises the substrate comprises ground grain, grain flour, ground potato and/or potato flour. In an embodiment of the invention, the substrate comprises milled grain, particulate grain or grain flour, with an average particle size of between 0.1 mm and 4 mm, preferably 0.2 mm-2 mm, more preferably 0.5-1 mm, the average particle size determined with ASTM C136/C136M-14 Standard Test Method for Sieve Analysis (version 1 Dec. 2014). The use of such fine grain particles, similar to consumer flour or milled grain provided as feedstock for rearing pigs, contributes to efficient application of the spent substrate in soil.

An embodiment is the biomass composition according to the invention, wherein the substrate further comprises water, preferably at a level of 10%-60% water by weight of the substrate, more preferably 20%-50% by weight, most preferably 30%-45% by weight.

After the stage wherein the insects grow and in some embodiments multiply, while feeding on the substrate, the insects are harvested. Harvesting of insects is typically done using machinery that is capable of separating intact insects, including adult insects and larvae, from the substrate, while leaving behind remains of insects such as heads, wings, legs, body parts, skin, thorax, abdomen, intestine, exoskeleton, fragmented exoskeleton, cut insects, smashed insects, decomposed insects, disintegrated insects, dried out insects, etc. in the spent substrate. In preferred embodiments of the invention, the spent substrate is subjected to an operation wherein these remains are (further) fragmented into particles of defined size and wherein the substrate is processed into a meal or powder that is easy to handle, e.g. by combining and mixing it with soil. This may be accomplished by subjecting the spent substrate to a grinding or milling operation or the like. This can be done using conventional machinery. In one particularly preferred embodiment of the invention the spent substrate is treated in a roller mill, preferably a corrugated roller mill.

It may be desirable to reduce the moisture content of the spent substrate, which may take place before or after the grinding or milling, preferably after. Drying can be carried out in conventional manners, e.g. using a single pass or dual pass oven or conveyor dryer, a rotary drum dryer, a ring dryer, a flash dryer, a spray dryer, a spin flash dryer, a super-heated steam dryer, etc. In preferred embodiments of the invention drying is carried out in an oven or by applying refractive drying. The person skilled in the art is capable, as a matter of routine practice, to determine suitable/optimal operating conditions, taking into account the specific properties of the substrate and machinery used. In preferred embodiments of the invention, the drying is carried out in such a way that the temperature of the substrate is kept below 85° C., preferably it is kept below 75° C., more preferably it is kept below 70° C.

The crop protection agents of the invention, such as the crop protection agent obtainable by the processes defined herein, comprise insect remains. Said insect remains are typically fragmented by the grinding or milling operation to yield smaller particles. In preferred embodiments of the invention, the insect remains have an average particle size of between 0.1 mm and 4 mm, preferably 0.2 mm-2 mm, more preferably 0.5-1 mm, the average particle size determined with ASTM C136/C136M-14 Standard Test Method for Sieve Analysis (version 1 Dec. 2014). An embodiment is the biomass composition according to the invention, wherein the insect remains have an average particle size of between 3 mm and 40 mm, preferably 5 mm-30 mm, more preferably 8-20 mm, the average particle size determined with ASTM C136/C136M-14 Standard Test Method for Sieve Analysis (version 1 Dec. 2014). A sieve analysis (or a gradation test) is a practice or procedure used to assess the particle size distribution (gradation) of a granular material (particulate material) by allowing the particulate material to pass through a series of sieves of progressively smaller mesh size, and weighing the amount of particulate material that is retained by each individual sieve as a fraction of the whole mass (as executed according to ASTM C136/C136M-14 Standard Test Method for Sieve Analysis, the version of the standard as published in the “Book of Standards”, Volume 04.02, with last changes approved by ASTM at 1 Dec. 2014).

In preferred embodiments, the crop protection agents of the invention, such as the crop protection agent obtainable by the processes defined herein, comprises insect particles in defined amounts. In certain embodiments of the invention, a crop protection agent as defined herein is provided comprising insect particles in an amount of at least 25% (w/w), on the basis of the dry weight of the composition. In preferred embodiments of the invention, the crop protection agent comprises insect particles in an amount of at least 40% (w/w), more preferably at least 50% (w/w), most preferably at least 60% (w/w).

In preferred embodiments of the invention, the crop protection agent comprises insect particles in an amount below 80% (w/w), more preferably below 75% (w/w), most preferably below 70% (w/w).

In preferred embodiments, the crop protection agents of the invention, such as the crop protection agent obtainable by the processes defined herein, comprises chitin in defined amounts. In certain embodiments of the invention, a crop protection agent as defined herein is provided comprising chitin in an amount of at least 0.25% (w/w), on the basis of the dry weight of the composition. The chitin content of the crop protection agent can be, and preferably are, determined using the method described by Hahn et al. (New methods for high-accuracy insect chitin measurement, J Sci Food Agric (2018) October; 98(13):5069-5073), in particular by the ADF-ADL method described there in. In preferred embodiments of the invention, the chitin content is at least 0.5% (w/w), on the basis of the dry weight of the composition, more preferably at least 0.75% (w/w), most preferably at least 1% (w/w). In preferred embodiments of the invention, the chitin content is below 15% (w/w), more preferably below 12.5% (w/w), more preferably below 10% (w/w), most preferably below 7.5% (w/w). In other preferred embodiments of the invention, the chitin content is at least 3% (w/w), on the basis of the dry weight of the composition, more preferably at least 5% (w/w), most preferably at least 6% (w/w). In particularly preferred embodiments of the invention, the chitin content is within the range of 0.2-15% (w/w), on the basis of the dry weight of the composition, preferably within the range of 1-12.5% (w/w), more preferably within the range of 2.5-10% (w/w).

In preferred embodiments, the crop protection agents of the invention, such as the crop protection agent obtainable by the processes defined herein, comprises insect excrements in defined amounts. In certain embodiments of the invention, a crop protection agent as defined herein is provided comprising such excrements in an amount of at least 15% (w/w), on the basis of the dry weight of the composition.

In preferred embodiments of the invention, the content of excrements is at least 20% (w/w), more preferably at least 25% (w/w), most preferably at least 27% (w/w). In preferred embodiments of the invention, the Content of excrements is below 85% (w/w), more preferably below 80% (w/w), most preferably below 77% (w/w).

In preferred embodiments, the crop protection agents of the invention, such as the crop protection agent obtainable by the processes defined herein, comprises water in defined amounts. In certain embodiments of the invention, a crop protection agent as defined herein is provided, having moisture content of below 10% (w/w), on the basis of the total weight. The moisture content can suitably be determined by AOAC 2016 method 925.10. In preferred embodiments of the invention, the moisture content is below 8% (w/w), more preferably below 7% (w/w), most preferably below 6% (w/w). In preferred embodiments of the invention, the moisture content is at least 1% (w/w), more preferably at least 2% (w/w), most preferably at least 3% (w/w).

In preferred embodiments, the crop protection agents of the invention, such as the crop protection agent obtainable by the processes defined herein, has a defined bulk density. In one preferred embodiment of the invention, a crop protection agent as defined herein is provided having a bulk density within the range of 0.25-0.50 kg/L. In preferred embodiments of the invention, the density is within the range of 0.30-0.45 kg/L, more preferably within the range of 0.35-0.40 Kg/L.

In certain embodiments of the invention the crop protection agent comprises one or more additives, typically one or more additives selected from plant growth additives, soil-adjustment additives, extenders and/or seed protection additives. Specific examples of such additives include bio-stimulants such as humic acid, fulvic acid, nitrogen containing compounds, inorganic compounds, acetic acid, seaweed extracts, botanicals, chitosan, biopolymers, fungi, bacteria, organic or synthetic fertilizers, biocontrol agents, pesticides, i.e. herbicides, fungicides and insecticides, a pH-modifier, a UV-stabiliser, lactic acid, an absorbent polymer such as silica, bentonite and super absorbing polymer, calcium carbonate and talcum.

In preferred embodiments of the invention, the crop protection agents as defined here above, especially dried forms of the crop protection agent, are provided in a suitable packaging, such as standard Big bags (1000 kg) or similar types of bags of different size, e.g. within the range of 25 kg or more. In other embodiments of the invention the crop protection agent may be provided in packages (and portions) more suited for (consumer) use in horticulture, e.g. in a plastic bag or cardboard packaging, typically ranging in size from 0.5 to 10 kg. In preferred embodiments the crop protection agent is dried before provided in packages (and portions).

In particularly preferred embodiments of the invention, a product is provided comprising a crop protection agent as defined herein, contained in a suitable package, such as a container, wherein a label or leaflet is physically associated with the package, said label or leaflet providing instructions to use the product for protecting a crop against insect pest by adding the crop protection agent to the soil wherein the crop to be protected from insect pest is grown. Preferably, said leaflet provides instructions to use the protect for protecting a crop against thrips pest. Preferably, the crop protection agent is provided with the insect rearing process as defined herein.

Preferred is a sealable container comprising a crop protection agent obtainable by the (insect rearing) process as defined herein, comprising the steps of:

providing a substrate;

inoculating the substrate with Hermetia illucens larvae;

allowing the Hermetia illucens larvae to grow and, if possible and suitable, optionally multiply on the substrate;
harvesting Hermetia illucens larvae from the spent substrate and collecting the spent substrate, wherein a label or leaflet is physically associated with the package, said label or leaflet providing instructions to use the product for protecting a crop against insect pest by adding the crop protection agent to the soil wherein the crop to be protected from insect pest is grown. Preferably, the crop protection agent is provided that is obtainable by an insect rearing process as defined herein, comprising the steps of:

providing a substrate;

inoculating the substrate with Hermetia illucens larvae;

allowing the Hermetia illucens larvae to grow and, if possible and suitable, optionally multiply on the substrate; and

harvesting Hermetia illucens larvae from the spent substrate and collecting the spent substrate.

In further preferred embodiments of the invention a product is provided in the form of a kit of parts, said kit of parts comprising a crop protection agent as defined herein contained in a first package as well as further treatment agent contained in a second package. In preferred embodiments, said further treatment agent comprises plant growth additive, soil-adjustment additive, extender and/or seed protection additive. Specific examples of such additives include bio-stimulants such as humic acid, fulvic acid, nitrogen containing compounds, inorganic compounds, acetic acid, seaweed extracts, botanicals, chitosan, biopolymers, fungi, bacteria, organic or synthetic fertilizers, biocontrol agents, pesticides, i.e. herbicides, fungicides and insecticides, a pH-modifier, a UV-stabiliser, lactic acid, an absorbent polymer such as silica, bentonite and super absorbing polymer, calcium carbonate and talcum. In a particularly preferred embodiment of the invention, the second treatment agent comprises live/viable soil improving bacteria. In a most preferred embodiment of the invention, the live/viable soil improving bacteria comprise one or more species capable of degrading chitin, such as Bacillus subtilis. In a preferred embodiment of the invention, the kit of parts comprises a label or leaflet, said label or leaflet providing instructions to use the product for protecting a crop against insect pest, preferably against thrips, by adding the crop protection agent as well as the further treatment agent to the soil wherein the crop to be protected from insect pest is grown. Preferably, the crop protection agent contained by the kit of parts is the crop protection agent that is obtainable by the insect rearing process as defined herein, comprising the steps of:
providing a substrate;
inoculating the substrate with Hermetia illucens larvae;
allowing the Hermetia illucens larvae to grow and, if possible and suitable, optionally multiply on the substrate; and
harvesting Hermetia illucens larvae from the spent substrate and collecting the spent substrate.

A further aspect of the invention concerns methods of treating agricultural or horticultural crops, using the crop protection agent as defined herein.

In accordance with the invention, the methods of treating are preferably aimed at one or more of the following objectives: controlling pest, such as insect pest or thrips pest; preventing pest, such as insect pest or thrips pest; preventing infestation of the crop by insects, such as thrips; protecting crop against infestation by pest insects, such as thrips; inhibiting growth and/or reproduction of insects, such as thrips, on the crop; reducing crop damage, especially crop damage due to insect pest or infestation, such as thrips pest or thrips infestation; improving crop yield; improving crop quality; etc.

As used herein, the term ‘insect pest’, in the context of the invention, refers to the phenomenon of crops being damaged by insects living on and/or in the vicinity of the crop. The term ‘pest insect’, in the context of the invention, refers to insects that typically cause damage to crops on which they live, feed and/or reproduce. Examples of pest insects include Hemipteran, thrips, Lepidopteran, Dipteran and Coleopteran larvae, spider mites, locust, crickets, ants, cockroaches, flies, wasps, termites, woodworms, wood ants, bookworms, silverfish and carpet beetles. particularly preferred embodiments of the invention, the (pest) insect is selected from the group consisting of sap-sucking insects. As used herein, the term “sap-sucking insect” refers to any insects that feed upon the sap contained within plant tissue by piercing or damaging the surface. Examples of sap sucking insects include aphids, thrips, scale insects, psyllids (also known as, jumping plant lice), whiteflies (which fall into Sternorryncha, in the Family Aleyroididae), leafhoppers, stink bugs, tarnished plant bugs, squash bugs, and spider mites.

In particularly preferred embodiments of the invention, the (pest) insect is selected from the group consisting of thrips. As used herein, the term “thrips” includes any member of the order Thysanoptera. The order Thysanoptera includes the suborders Terebrantia and Tubulifera, the super families of Aeolothripoidea, Thripoidea, and Merothripoidea, and the families of Aeolothripidae, Heterothripidae, Thripidae, Uzelothripidae, and Phlaeothripidae. Specific varieties of thrips include greenhouse thrips (Heliothrips haemorrhoidalis), banded greenhouse thrips (Hercinothrips femoralis), flower thrips (Frankliniella tritici), Western flower thrips (WFT) (Frankliniella occidentalis), onion or tobacco thrips (Thrips tabaci), citrus thrips (Scirtothrips aurantii and Scirtothrips citri), cereals thrips (Limothrips cerealium), pea thrips (Kakothrips robustus), lily bulb thrips (Liothrips), black hunter thrips (Leptothrips mali), coffee thrips (Diarthrothrips), avocado thrips (Scirtothrips perseae), Thrips palmi, fruit tree thrips (Taeniothrips inconsequens), gladiolus thrips (Taeniothrips simplex), azalea thrips (Heterothrips azaleae), olive thrips (Liothrips oleae), six-spotted thrips (Scolothrips sexmaculatus), and cotton thrips (caliothrips sp. and Frankliniella sp.). Hence in a particularly preferred embodiment of the invention, the method is used for controlling thrips pest in an agricultural or horticultural crop; preventing thrips pest in an agricultural or horticultural crop; preventing infestation of an agricultural or horticultural crop by thrips; protecting an agricultural or horticultural crop against infestation by thrips; inhibiting growth and/or reproduction of thrips on an agricultural or horticultural crop; reducing agricultural or horticultural crop damage due to thrips pest or thrips infestation. Most preferably, the thrips is Western Flower Thrips (WFT) (Frankliniella occidentalis).

As used herein, the term ‘agricultural crop’ generally refers to plants of which a part or all is harvested or cultivated on a commercial scale or which serve as an important source of feed, food, fibers (e.g., cotton, linen), combustibles (e.g., wood, bioethanol, biodiesel, biomass) or other chemical compounds. Examples of crops include, but are not limited to, grains, fruits and fruit trees, and vegetables, such as cereals, e.g., wheat, rye, barley, triticale, oats, sorghum or rice; beet, e.g., sugar beet or fodder beet; leguminous plants, such as lentils, peas, alfalfa or soybeans; oil plants, such as rape, oil-seed rape, canola, juncea (Brassica juncea), linseed, mustard, olives, sunflowers, cocoa beans, castor oil plants, oil palms, ground nuts or soybeans; cucurbits, such as squashes, cucumber or melons; fiber plants, such as cotton, flax, hemp or jute; vegetables, such as cucumbers, spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, canola, sugar cane or oil palm; corn; tobacco; nuts; coffee; tea; vines; hop; turf and natural rubber plants. As used herein, the term ‘horticultural crop’ generally refers to plants that are cultivated (on a commercial scale) for ornamental/decorative purposes, e.g. ornamental garden plants and decorative flowers. Examples of horticultural crops include African violet, alstreomeria, aster, azalea, begonia, cacti, calceolaria, celosia, cineraria, cyclamen, chrysanthemum, dalia, exacum, gladiolus, geranium, gerbera, gloxinia, gypsophila, hibiscus, hydrangea, impatiens, kalanchoe, lily, lisianthus, oxalis, primula, petunia, poinsettia, rose, snapdragon, stocks, and stephanotis.

In a preferred embodiment, the crop treated in accordance with the invention is a crop grown in a greenhouse. In a highly preferred embodiment, the crop treated in accordance with the invention is a crop that is particularly sensitive to (damage by) thrips. In a highly preferred embodiment, the crop treated in accordance with the invention is a crop that is particularly sensitive to (damage by) western flower thrips. Preferred examples of crops to be treated in accordance with the invention include radish, chrysanthemum, strawberries, orchid, organic vegetables and fruits, etc.

In accordance with the present invention, the crop protection agent may be used to treat the soil in which a crop is grown as well as the treatment of the plant parts growing above the ground or both.

Hence, in one embodiment of the invention, a method as defined herein is provided, comprising applying to the crop, especially to the leaves, an effective amount of the crop protection agent as defined herein. In particularly preferred embodiments, the methods of the invention comprise applying to the soil in which the crop is grown an effective amount of the crop protection agent as defined herein. In certain embodiments of the invention, the crop protection agent is in the form of a meal or powder, which is mixed directly with soil, directly applied on the soil surface or directly applied onto the crop. In other embodiments, the crop protection agent is in the form of a meal or powder, which is mixed with a liquid, such as (tap) water, to produce a dispersion that can be combined with the soil, sprayed over the soil surface or sprayed over the crop. In other embodiments, the crop protection agent is in the form of a meal or powder, which is mixed with a liquid, such as (tap) water, after which the liquid fraction, comprising solutes from the meal or powder, is taken from the mixture and sprayed over the crop.

In an embodiment of the invention, the method comprises applying to the soil in which the crop is grown a mixture comprising an effective amount of the crop protection agent as well as an effective amount of a further treatment agent comprising bacteria, such as soil improving bacteria. Most preferably the further treatment agent comprises at least one species of live/viable bacteria capable of degrading chitin. An example of a further treatment agent comprising live/viable soil improving bacteria that is particularly suitable for use in accordance with the invention is available (in liquid as well as powder form) under the brand name Biovin®. In preferred embodiments of the invention, the crop protection agent and the further treatment agent are combined prior to mixing with or application on the soil. In preferred embodiments of the invention, the crop protection agent is in the form of a meal or powder and the further treatment agent is a liquid and the method comprises the step of mixing the two to produce a liquid dispersion that is combined with soil or sprayed on the soil surface.

In preferred embodiments, the crop protection agent is used to treat crops grown in containers, pots or trays and the soil and crop protection agent are mixed prior to filling the containers, pots or trays. In preferred embodiments, such methods comprise adding the crop protection agent of the invention to the soil in an amount of at least 10 g per kg of soil, more preferably at least 20 g per kg of soil, at least 30 g per kg of soil, at least 40 g per kg of soil, or at least 50 g per kg of soil. The exact amount will depend on the composition of the crop protection agent, e.g. on the water content. For example, in case the crop protection has a dry matter content of above 75% (w/w), e.g. around 90% (w/w), said amount is preferably in the range of 10-100 g per kg of soil, more preferably 15-75 g/kg of soil, most preferably 20-50 g/kg of soil. in case the crop protection has a dry matter content of below 60% (w/w), e.g. around 45% (w/w), e.g. in case fresh (undried) substrate is used, said amount is preferably in the range of 20-200 g per kg of soil, more preferably 30-150 g/kg of soil, most preferably 50-100 g/kg of soil.

In preferred embodiments of the invention, these methods comprise adding the crop protection agent of the invention to the soil in amounts providing insect particles in a quantity of at least 6.5 g per kg of soil, more preferably at least 13 g per kg of soil, at least 19.5 g per kg of soil, at least 26 g per kg of soil, at least 32.5 g per kg of soil.

In preferred embodiments of the invention, these methods comprise adding the crop protection agent of the invention to the soil in amounts providing chitin in a quantity of at least 0.025 g per kg of soil, more preferably at least 0.050 g per kg of soil, at least 0.075 g per kg of soil, at least 0.1 g per kg of soil, or at least 0.15 g per kg of soil. The methods typically comprise adding the crop protection agent of the invention to the soil in amounts providing chitin at a quantity of less than 1.5 g/kg. In other preferred embodiments of the invention, these methods comprise adding the crop protection agent of the invention to the soil in amounts providing chitin in a quantity of at least 0.3 g per kg of soil, more preferably at least 0.5 g per kg of soil, at least 0.6 g per kg of soil, at least 0.7 g per kg of soil, or at least 0.8 g per kg of soil.

In other embodiments, the crop protection agent is used to treat crops grown in a field and the crop protection agent is applied to the field. In preferred embodiments, such methods comprise adding the crop protection agent of the invention to the soil or applying the crop protection agent over the field and/or over the crop, in an amount of at least 0.25 kg/m², such as at least 0.50 kg/m², at least 0.75 kg/m², at least 1 kg/m², at least 1.5 kg/m² or at least 2 kg/m². The exact amount will depend on the composition of the crop protection agent, e.g. on the water content. For example, in case the crop protection has a dry matter content of above 75% (w/w), e.g. around 90% (w/w), said amount is preferably in the range of 0.5-2.5 kg/m², more preferably within the range of 1-2.5 kg/m², most preferably within the range of 1.5-2 kg/m². In case the crop protection has a dry matter content of below 60% (w/w), e.g. around 45% (w/w), e.g. in case fresh (undried) substrate is used, said amount is preferably said amount is preferably in the range of 1-5 kg/m², more preferably within the range of 2-4.5 kg/m², most preferably within the range of 2-4 kg/m².

In preferred embodiments of the invention, these methods comprise adding the crop protection agent of the invention to the soil or applying the crop protection agent over the field and/or over the crop, in amounts providing insect particles in a quantity of at least 0.16 kg/m², such as at least 0.32 kg/m², at least 0.48 kg/m², at least 0.65 kg/m², at least 0.97 kg/m².

In preferred embodiments of the invention, these methods comprise adding the crop protection agent of the invention to the soil or applying the crop protection agent over the field and/or over the crop, in amounts providing chitin in a quantity of at least 0.0025 kg/m², such as at least 0.005 kg/m², at least 0.0075 kg/m², at least 0.01 kg/m², or at least 0.015 kg/m². In other preferred embodiments of the invention, these methods comprise adding the crop protection agent of the invention to the soil or applying the crop protection agent over the field and/or over the crop, in amounts providing chitin in a quantity of at least 0.02 kg/m², such as at least 0.04 kg/m², at least 0.06 kg/m², or at least 0.08 kg/m², at least 0.1 kg/m². Typically, the methods of the invention comprise treatment of the soil, the field and/or the crop with crop protection agent at least once per growth cycle of the crop. Preferably, the treatment is done prior to crop seeding or planting. In embodiments of the invention, the methods may comprise repeated addition of the crop protection agent to the soil or application of the crop protection agent over the field and/or crop, periodically, such as once every six months, once every four months, once every three months, once every two months, once every month, once every two weeks or once a week.

A further aspect of the invention concerns the use of the present crop protection agent for crop treatments as defined herein. In preferred embodiments, use of the present crop protection agent is provided for controlling pest, such as insect pest or thrips pest, preferably thrips pest; preventing pest, such as insect pest or thrips pest, preferably thrips pest; preventing infestation of the crop by insects, such as thrips, preferably thrips; protecting crop against infestation by pest insects, such as thrips, preferably thrips; inhibiting growth and/or reproduction of insects, such as thrips, preferably thrips, on the crop; reducing crop damage, especially crop damage due to insect pest or infestation, such as thrips pest or thrips infestation, preferably thrips pest or thrips infestation; improving crop yield; improving crop quality; etc. Preferably, the method is used for controlling thrips; preventing thrips pest; preventing infestation of the crop by thrips; protecting crop against infestation by thrips; inhibiting growth and/or reproduction of thrips on the crop; reducing crop damage due to thrips pest or infestation. Most preferably, the thrips is Western Flower Thrips (WFT) (Frankliniella occidentalis). It will be understood by those skilled in the art, based on the present teachings, that these uses entail the treatment of soil in accordance with what is explained and defined here above, in relation to the method of treatment. In preferred embodiments of the invention, combined uses of a crop protection agent and a further treatment agent are provided, preferably a further treatment agent comprising live/viable soil improving bacteria, preferably live/viable bacteria capable of degrading chitin.

A further aspect of the invention concerns enhanced soil systems obtainable by the methods of the invention. In preferred embodiments, the invention provides a plant growing container, pot or tray suitable for growing an agricultural or horticultural crop, such as the types typically used in greenhouse farming, said container, pot or tray being filled with a mixture of soil and the crop protection agent. In preferred embodiments, the enhanced soil system comprises the crop protection agent in an amount of at least 10 g per kg of soil, more preferably at least 20 g per kg of soil, at least 30 g per kg of soil, at least 40 g per kg of soil, or at least 50 g per kg of soil. In preferred embodiments of the invention, the enhanced soil system comprises chitin at a quantity of at least 0.025 g per kg of soil, more preferably at least 0.05 g per kg of soil, at least 0.075 g per kg of soil, at least 0.1 g per kg of soil, or at least 0.15 g per kg of soil. In other preferred embodiments of the invention, the enhanced soil system comprises chitin at a quantity of at least 0.3 g per kg of soil, more preferably at least 0.5 g per kg of soil, at least 0.6 g per kg of soil, at least 0.7 g per kg of soil, or at least 0.8 g per kg of soil. It is preferred that the enhanced soil system, comprising a mixture of soil and the crop protection agent of the invention, is an enhanced soil system for controlling thrips pest in an agricultural or horticultural crop. Typically, the enhanced soil system of the invention is for controlling thrips pest; preventing thrips pest; preventing infestation of the crop by thrips; protecting crop against infestation by thrips; inhibiting growth and/or reproduction of thrips, on the crop; reducing crop damage, especially crop damage due to thrips pest or thrips infestation; improving crop yield; improving crop quality; etc. Preferably, the enhanced soil system is applied for controlling thrips; preventing thrips pest; preventing infestation of the crop by thrips; protecting crop against infestation by thrips; inhibiting growth and/or reproduction of thrips on the crop; reducing crop damage due to thrips pest or infestation.

The present invention has been described with respect to particular embodiments but the invention is not limited thereto. The embodiments of the invention described herein can operate in combination and cooperation, unless specified otherwise.

Unless defined otherwise, all technical terms and scientific terms used herein have the same meaning as commonly understood by the relevant skilled person. Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Furthermore, the various embodiments, although referred to as “preferred” or “e.g.” or “for example” or “in particular” are to be construed as exemplary manners in which the invention may be implemented rather than as limiting the scope of the invention.

The term “comprising”, used in the claims, should not be interpreted as being restricted to the elements or steps listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising A and B” should not be limited to devices consisting only of components A and B, rather with respect to the present invention, the only enumerated components of the device are A and B, and further the claim should be interpreted as including equivalents of those components.

The invention will be illustrated by means of the following examples, which do not limit the scope of the invention in any way.

### EXAMPLES

### Example 1: Production of Wet Insect Substrate

A substrate comprising of potato and cereals processing by products was produced. Black soldier fly larvae were reared on this substrate. Relevant details of the rearing conditions are summarized in Table 1. The spent substrate that was left after harvesting of the larvae (after 6 days of rearing on the substrate) was collected as the ‘wet substrate’, which was directly used for the field tests (described here after).

TABLE 1
rearing conditions

| | |
|---|---|
| Age of larvae (at start of rearing) | 8 days |
| Age of larvae (at end of rearing) | 14 days |
| Amount of feed during the rearing cycle/insect | 0.56 g |
| Amount of substrate produced/insect | 0.13 g |
| Temperature of substrate (during harvest): | 38° C. |

### Example 2: F. occidentalis Pest Control Usinq Insect Substrate

F. occidentalis (Californian thrips) is an invasive species that is notoriously difficult to control. In addition to the problem of resistance against plant protection products, F. occidentalis does not hibernate and is a year-round problem. The life cycle consists of the following developmental stages: egg, two larval instars, to pupal stages and adult. The duration of the cycle is 10.9 to 15.2 days at a temperature of between 25° C. and 30° C.). F. occidentalis does not eat during pupation and usually stays in the ground up to 15 mm deep. Adults feed by puncturing the plant cells on the surface and sucking up the cell contents.

In this experiment, the inhibitory activity on F. occidentalis resulting from soil treatment with the wet insect substrate as produced in example 1 is investigated.

### Materials & Methods

F. occidentalis were kept in insect nets (Bugdorm-4F) with a mesh size of 150×150 μm at 25-28° C. in the greenhouse of HAS Hogeschool, 's-Hertogenbosch (the Netherlands). Rhapanus sativus var. Sativus (garden radish) was used as a model crop.

In order to assess F. occidentalis development at different levels of the wet insect substrate (in soil), five levels were used, notably 0%, 1%, 2%, 5% and 10% (percentages on a w/w basis). The insect substrate is produced in accordance with the procedure of example 1 and was supplied by Protix b.v. (The Netherlands) and contains approximately 65%, on the basis of the total weight of the wet substrate, of insect particles (i.e. matter originating from the insects, including the insect remains, excrements and other insect waste products). The wet substrate is homogeneously mixed with bacteria-rich substrate Biovin® (1%) and potting soil from BVB substrates (The Netherlands), clay/primula brand. Plant pots (23 cm×17 cm×7 cm) are filled with the mixture and four Radish plants are sown per pot (t=0). Each insect substrate level was tested in six different pots. Two pots were placed in each insect net. Ten female F. occidentalis are placed under each insect net at the 14^{th} day of the test (t=14). The insect nets containing the plant pots are placed in the greenhouse randomly.

In each insect net one insect trap plate of the Biobest brand is placed (t=28). F. occidentalis numbers were counted (t=42).

For each radish plant, the deterioration of the leaf was assessed on the basis of an estimate of the percentage of discolouration (t=28; 35; 42).

All results were analysed in SPSS statistics 25. Using two-way ANOVA, it was tested whether there was a significant difference in the number of F. occidentalis between the various treatments and in relation to the control. Radish plant (leaf) deterioration over time was statistically compared (between the various treatments) to repeated measures. The weight of the radishes was compared using two-way ANOVA (p<0.05).

### Results

The results (insect counts) are summarized in Table 2. As can be seen, the use of insect substrate at a 10% level, resulted in a 60.9% lower number of Frankliniella occidentalis, compared to control (no addition of insect substrate) (P<0.05) (see FIG. 1). A large spread was observed with 2% insect substrate (SE=17.8).

TABLE 2
P-values for the number of Frankliniella occidentalis vs. percentages
insect substrate using ANOVA. * Significant difference (0.05).

| Percentage insect substrate (v/v) | Relative to | P-value |
|---|---|---|
| 0% | 1% | 0.827 |
| | 2% | 0.870 |
| | 5% | 0.074 |
| | 10%* | 0.031 |
| 1% | 0% | 0.827 |
| | 2% | 0.956 |
| | 5%* | 0.047 |
| | 10%* | 0.019 |
| 2% | 0% | 0.870 |
| | 1% | 0.956 |
| | 5% | 0.053 |
| | 10%* | 0.022 |
| 5% | 0% | 0.074 |
| | 1%* | 0.047 |
| | 2% | 0.053 |
| | 10% | 0.678 |
| 10% | 0%* | 0.031 |
| | 1%* | 0.019 |
| | 2%* | 0.022 |
| | 5% | 0.678 |

The 10% treatment resulted in significantly less leaf discoloration of Rhapanus sativus over time (P<0.05). Discoloration score decreases from t=15 and increases again at t=29 (FIG. 2). The 0%, 1% and 2% treatments resulted in the highest discoloration scores over time (P<0.001). The discoloration scores are summarized in Table 3.

TABLE 3
P-values for discoloration of Rhapanus sativus
leaf over 35 days (Friedman test).

| Insect substrate (% v/v) | P-value |
|---|---|
| 0% | P < 0.001 |
| 1% | P < 0.001 |
| 2% | P < 0.001 |
| 5% | P = 0.056 |
| 10% | P = 0.002 |

### Discussion and Conclusion

The use of insect substrate for reducing pests in greenhouses gives positive results. An addition of 10% (v/v) of insect substrate (69.9 grams/liter) reduces F. occidentalis by 61%. This decrease could be explained by the fact that chitin acts as a resistance-enhancing agent in plants. This idea is supported by the fact that plants treated with insect substrate appear greener later in the growth stage compared to the control. Possibly plants are less affected by F. occidentalis because F. occidentalis experiences difficulty feeding as a result of increased resistance. Plants treated with insect substrate at a 10% level were more yellow in the early growth stages compared to the control. It is hypothesized that chitin acts as an elicitor. It has been suggested in the art that plants growing in the presence of an elicitor grow more slowly in the early stages and recover later. A trade-off may take place, where the elicitor initially stimulates certain (defensive) metabolic mechanisms at the expense of growth in the early stages. The metabolic advantages better defend the plant against pests, in this case against F. occidentalis, actually enabling the plant to make up for slow initial growth. The current results thus suggest that insect substrate actually works as an elicitor and is effective against pest insects also during the non-underground stages of their lifecycle.

### Example 3: Effect of Insect Substrate on Growth of Crop in Absence of Pests

An experiment was conducted in order to assess the influence of insect substrate (as produced in accordance with Example 1) on crop performance in the absence of insect pests. The experiment was performed over a span of 35 days.

### Methods & Materials

Raphanus sativus var. Solito F1, supplied by Hazera (The Netherlands), is bred in the greenhouse of HAS Hogeschool, 's Hertogenbosch, The Netherlands, at an average temperature of 21° C. and 70% humidity.

The soil mixture used for the experiment comprises potting soil (BVB substrates, clay/primula), Biovin® and insect substrate (prepared according to the protocol of Example 1 and supplied by Protix, the Netherlands). Biovin® is used at a 1% level in the soil mixture, based on the total weight of the mixture. The insect substrate is added to the mixture at levels of 0% (control), 1% 2%, 5%, 10% and 20%, based on the total weight of the mixture. The insect substrate comprises 75.8% organic matter and 7-8% chitin per kg substrate. At t=0, plastic plant pots of 650 mL are filled with the soil mixture and the plant seeds are sowed. Plants are watered three times a week using the sprinkler system installed in the greenhouse.

In total 3 repeats (n=90 plant pots) were performed, which were divided into 6 groups (n=15), which is 1 group per level of insect substrate in the soil mixture (i.e. 0%, 1%, 2%, 5%, 10%, 20%). For every repeat 180 seeds were sown, which equals 2 seeds per plant pot, on day 7 (t=7). One week later (t=14) 90 radishes, 1 from each plant pot, were selected using uniformity as a criterion. The plants were positioned at random.

During the experiment the diameter of the leaf base is measured using a caliper gage (t=21, t=28 and t=35). After harvest, the largest diameter of the tuber is measured using a caliper gage and the length of the roottip to the leaf base is measured using a measuring tape (t=35) (see FIG. 3).

After harvest the fresh weight of the radish with and without the leaf is determined (t=35). To that end, the radish is harvested from the soil and rinsed with water to remove the soil remaining on the radish. Subsequently, the radish is allowed to dry for 10 minutes and weighed using an Ohaus TAJ 602 scale. In the second round of the experiment, the dry weight is also determined. To that end, radishes without leaf are placed in a drying oven at a temperature of 105° C. for 24 hours. The radishes are subsequently analyzed by comparing different groups, attempting to establish correlations. For all determinations ANOVA is used.

### Results

Addition of the soil comprising 20% of the substrate results in a lower fresh weight of the radish (tuber) when compared to the fresh weights of the radishes grown in soil comprising 0%, 1%, 2%, 5% or 10% substrate (P<0.05) (see FIG. 4a). No significant differences were observed between the radishes grown in soil comprising 0%, 1%, 2%, 5% and 10% substrate (P>0.05)

The fresh weight of the leaves of the radishes grown in soil comprising 10% substrate show a significant difference with the fresh weight of the leaves of the radishes grown in soil comprising 1% substrate (P<0.05 No significant differences (P>0.05) were shown between the fresh weight of the leaves of radishes grown in soil comprising 0%, 2%, 5% and 20% (see FIG. 4b)

An addition of 20% substrate to soil results in a lower dry weight of the radish than the soil comprising 0%, 1%, 2%, 5% and 10% substrate (P<0.05) (see FIG. 4c). No significant difference (P>0.05) was shown between the dry weight of radishes grown in soil comprising 0%, 1%, 2%, 5% and 10%.

### DESCRIPTION OF THE DRAWINGS

FIG. 1: number of Frankliniella occidentalis after the use of insect substrate compared to control (no addition of insect substrate)

FIG. 2: Leaf discoloration of Rhapanus sativus over time after the use of insect substrate (at various levels) and compared to control (no addition of insect substrate).

FIG. 3: Measuring points: A=widest part of the tuber. B=leaf base. C=length of the root tip to the leaf base.

FIG. 4a: Average fresh weight of radish tuber grown in soil mixture comprising different percentages of insect substrate.

FIG. 4b: Average fresh weight of radish leaves grown in soil mixtures comprising different percentages of insect substrate.

FIG. 4c: Average dry weight of radishes grown in soil mixtures comprising different percentages of insect substrate.

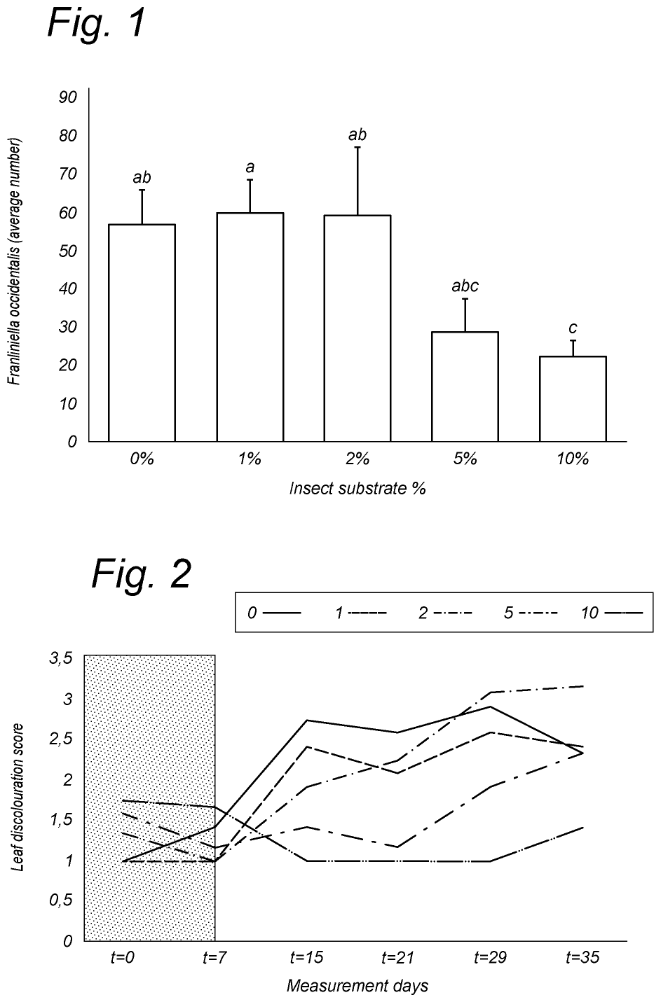

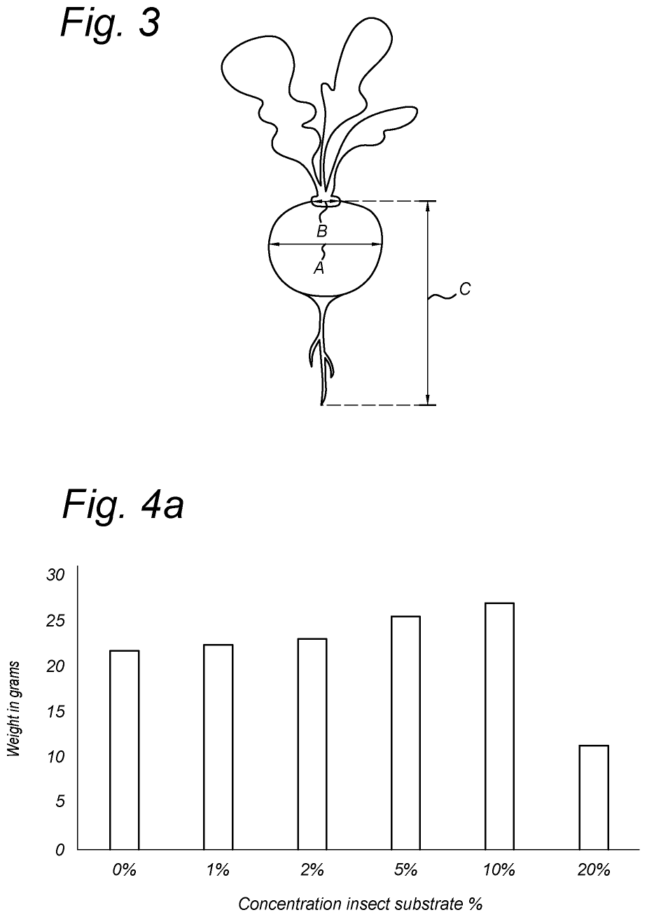

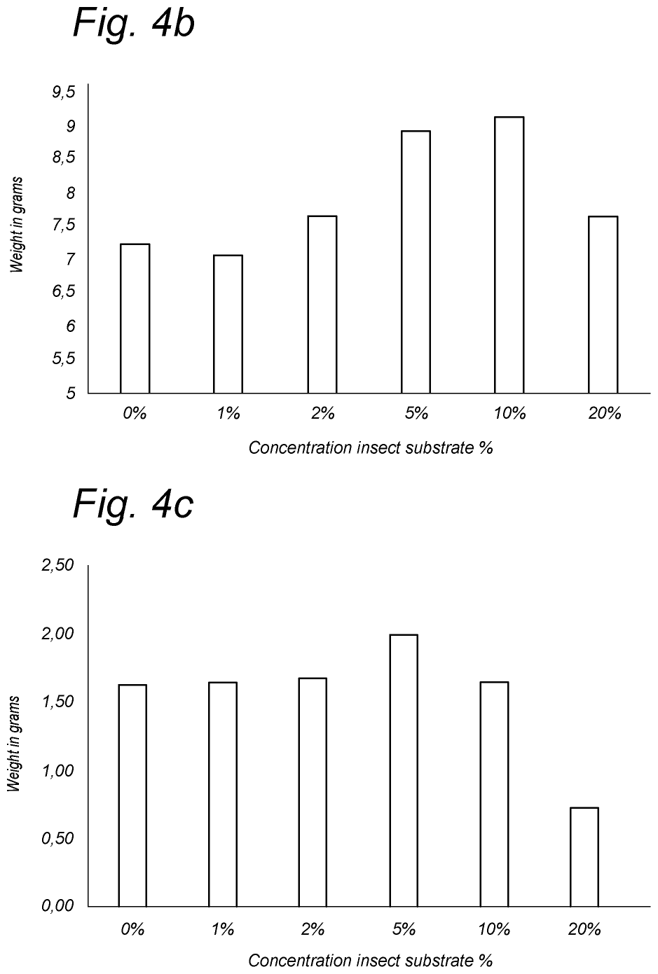

1. Method of controlling thrips pest in an agricultural or horticultural crop, said method comprising applying to the crop or to the soil in which the crop is grown an effective amount of a crop protection agent comprising a meal or powder produced from a spent Hermetia illucens rearing substrate, said crop protection agent comprising chitin-containing Hermetia illucens particles.

2. The method according to claim 1, wherein the crop protection agent further comprises Hermetia illucens larval excrements.

3. The method according to claim 1, wherein the crop protection agent is a meal or powder produced from a spent Hermetia illucens rearing substrate.

4. The method according to claim 3, wherein the crop protection agent is produced from a spent substrate used to rear Hermetia illucens, preferably Hermetia illucens larvae.

5. The method according to claim 1, wherein the crop protection agent is obtainable by a process comprising the steps of:
providing a substrate;
inoculating the substrate with Hermetia illucens insects;
allowing the Hermetia illucens insects to grow and, if possible and suitable, optionally multiply on the substrate;
harvesting the Hermetia illucens insects from the spent substrate and collecting the spent substrate; and
optionally subjecting the spent substrate to one or more further operations, in particular to one or more further operations selected from milling or grinding; drying; mixing with one or more additives; and packaging.

6. The method according to claim 5, wherein the substrate comprises ground grain, grain flour, ground potato and/or potato flour.

7. The method according to claim 1, for preventing and/or combating infestation of said agricultural or horticultural crop by Frankliniella occidentalis.

8. The method according to claim 1, wherein said crop protection agent is applied at a level of at least 70 g per kg of soil.

9. The method of claim 1, comprising applying a meal or powder produced from a spent Hermetia illucens rearing substrate and chitin containing Hermetia illucens insect particles for controlling thrips pest in an agricultural or horticultural crop; preventing thrips pest in an agricultural or horticultural crop; preventing infestation of an agricultural or horticultural crop by thrips; protecting an agricultural or horticultural crop against infestation by thrips; inhibiting growth and/or reproduction of thrips on an agricultural or horticultural crop; reducing agricultural or horticultural crop damage due to thrips pest or thrips infestation.

10. The method according to claim 9, wherein the crop protection agent further comprises Hermetia illucens larval excrements.

11. The method according to claim 9, wherein the crop protection agent is a meal or powder produced from a spent Hermetia illucens insect rearing substrate.

12. The method according to claim 9, wherein the crop protection agent is obtainable by a process comprising the steps of:
providing a substrate;
inoculating the substrate with Hermetia illucens insects;
allowing the Hermetia illucens insects to grow and, if possible and suitable, optionally multiply on the substrate;
harvesting the Hermetia illucens insects from the spent substrate and collecting the spent substrate; and
optionally subjecting the spent substrate to one or more further operations, in particular to one or more further operations selected from milling or grinding; drying; mixing with one or more additives; and packaging.

13. A sealable container comprising a crop protection agent obtainable by the process comprising the steps of:
providing a substrate;
inoculating the substrate with Hermetia illucens insects;
allowing the Hermetia illucens insects to grow and, if possible and suitable, optionally multiply on the substrate;
harvesting the Hermetia illucens insects from the spent substrate and collecting the spent substrate; and
optionally subjecting the spent substrate to one or more further operations, in particular to one or more further operations selected from milling or grinding; drying; mixing with one or more additives; and packaging,
wherein a label or leaflet is physically associated with the container, said label or leaflet providing instructions to use the product for protecting a crop against thrips pest by adding the crop protection agent to the soil wherein the crop to be protected from trips pest is grown.

14. The container of claim 13, wherein the crop protection agent is contained in a first package and comprising a further treatment agent contained in a second package.

15. An enhanced soil system, comprising a mixture of soil and the crop protection agent obtainable by the process comprising the steps of:
providing a substrate;
inoculating the substrate with Hermetia illucens insects;
allowing the Hermetia illucens insects to grow and, if possible and suitable, optionally multiply on the substrate;
harvesting the Hermetia illucens insects from the spent substrate and collecting the spent substrate; and
optionally subjecting the spent substrate to one or more further operations, in particular to one or more further operations selected from milling or grinding; drying; mixing with one or more additives; and packaging.

16. The method according to claim 5, and further comprising the step of:
subjecting the spent substrate to one or more further operations; and packaging.

17. The method according to claim 16, wherein the one or more further operations is selected from milling or grinding, drying, and/or mixing with one or more additives.
